(19) United States
(12) Patent Application Publication
(10) Pub. No.: US 2002/0032003 A1
(43) Pub. Date: Mar. 14, 2002

(54) Multi-spot satellite system for broadband communication

(76) Inventors: Avraham Avitzour, Petah Tikva (IL); Arik Keshet, Petah Tikva (IL); Eran Agmon, Petah Tikva (IL)

Correspondence Address: BANNER & WITCOFF, 1001 G STREET N W, SUITE 1100, WASHINGTON, DC, 20001, US

(21) Appl. No.: 09/881,208

(22) Filed: Jun. 15, 2001

Related U.S. Application Data
(60) Provisional application No. 60/211,474, filed on Jun. 15, 2000.
(60) Provisional application No. 60/235,546, filed on Sep. 27, 2000.
(60) Provisional application No. 60/238,444, filed on Oct. 10, 2000.

(51) Int. Cl. H04B 7/185

(52) U.S. Cl. 455/12.1; 455/13.1

(57) ABSTRACT

The present invention relates to the field of two-way satellite communications and in particular, to high capacity multi-purpose satellite communication systems optimized for two-way broadband communications. The two satellites are collocated and utilize a complementary channel arrangement which facilitates full dual pole coverage continuity when one of the satellites fails. Four channels of either inbound or outbound may be associated with each spot-beam area. Two channels may be provided by each of the two co-located satellites and may be configured to have a specific predetermined relationship with each other.

### BACKGROUND OF THE INVENTION

The present invention relates to the field of two-way satellite communications. More particularly, the present invention relates to high capacity multi-purpose satellite communication systems optimized for two-way broadband communications.

Residential two-way satellite communications have heretofore been commercially impractical for the average homeowner. The cost of the space segment, satellite dish, transceiver, and associated knowledge and support have been far too expensive for the average consumer or small business. Hence, the average consumer may well require access to a local phone company for multiple phone lines, a facsimile line, a high-speed data line and a cable company for television. The cost of all of these services may well exceed $200 per month and may only receive limited use by the home owner. In areas where there is satellite television provided, this service is often one-way due to the limitations of present day two-way broadband communication systems. Thus, current users of satellite television systems will not be able to participate in the coming wave of interactive television/Internet applications. To complicate matters, in many areas, cable television and high-speed data lines are not available at any price. Hence there is a need for a low cost two-way broadband satellite communication system that is affordable to the average consumer.

### SUMMARY OF THE INVENTION

In order to overcome the disadvantages of conventional systems, there are a number of objects and associated aspects of the present invention.

In aspects of the invention there are two co-located satellites, in which four channels of the same type (either inbound or outbound) may be associated with each spot-beam area. Two channels may be provided by each of two co-located satellites and may be configured to have a specific predetermined relationship with each other. The four channels may include two channels in each polarization direction.

Aspects of the invention also include using the above described channel arrangement which may facilitate hot back-up for a full satellite failure. For example, where there are two co-located satellites, if one satellite fails, the whole ground system covered by a spot beam array may be configured to continue operations even though the polarization of each ground terminal is fixed. In one aspect of the invention, this may be accomplished by utilizing at least two channels of the same type (inbound or outbound) in any given spot beam area in each of the two orthogonal polarization directions. Thus, it is possible to continue service with only a single channel per polarization per direction. Service may be continued by switching part of the remaining satellite channels to the other polarization direction and/or by configuring the channelization in a predetermined manner to provide redundant coverage. The configuration may be accomplished by a switch on the satellite and associated ground control via a suitable control mechanism such as a satellite control center. The satellite control center may be disposed in any suitable location.

Aspects of the present invention also provide for load balancing. For example, the system allows for flexibility like the unequal allocation of capacity between different spot beam areas. Where the demand for capacity is not equal in all spot beam areas, a channel may be switched from a low-demand spot beam area to high demand spot beam area. This may be accomplished via a switching and control mechanism disposed on the satellite and controlled from an earth based system such as the satellite control center.

In still further aspects of the invention, the channels may be spaced by a predetermined amount of frequency channels (e.g., four frequency channel where the range of frequencies is eight channels wide) so as not to interfere with each other or adjacent spot beams. For example, spot beam area A may receive satellite channels from satellite I on channels 1 and 5 both on the same polarization. Spot beam area A may also receive satellite channels from satellite II also using spaced frequencies such as 3 and 7—both on the same polarization—orthogonal to that of satellite I. Having channels arranged in this manner, e.g., channels 1 and 5 on a first polarization with channels 3 and 7 on a second polarization in the same spot beam, may provide optimal channel spacing and reduce interference.

Similarly, a second adjacent spot beam (spot beam area B) may receive satellite channels from Satellite I on channels 2 and 6 both on the same polarizations. Spot beam area B may also receive satellite channels from Satellite II also using spaced frequencies such as 4 and 8—both on the same polarization orthogonal to that of satellite I. Having channels arranged in this manner, e.g., channels 2 and 6 on a first polarization with channels 4 and 8 on a second polarization in the same spot beam may provide optimal channel spacing and reduce interference.

The set may comprise a group of spot beams which may be associated with a single Hub and may make use of the entire available frequency range. For example, the set may include four spot beams. In alternate configurations, the practical number of spot beams in a set may be 2, 3, 4, 5, 6, or 7. For many spot beam arrangements, having four spot beams per set provides an optimal configuration. With proper geographical arrangement, the satellite may include several sets employing frequency reuse.

A similar configuration may be replicated for any remaining spot beams in the same set. For example, Spot beam area C may receive satellite channels from Satellite I also using spaced frequencies such as 3 and 7—both on the same polarizations. Spot beam area C may also receive satellite channels from Satellite II also using spaced channels such as 1 and 5 both on the same polarization orthogonal to that of Satellite I. Similarly, Spot beam area D may receive satellite channels from Satellite I also using spaced frequencies such as 4 and 8—both on the same polarizations. Spot beam area D may also receive satellite channels from Satellite II also using spaced channels such as 2 and 6 both on the same polarization orthogonal to that of Satellite I.

In the above configuration, full two-way coverage of all spot beams may still be provided where one entire satellite fails.

In still further aspects of the invention, cross strap connectivity is provided in a single or dual satellite with the specific purpose of increasing usable space segment capacity for two way communication. Thus, by configuring the cross-strap connectivity, it is possible to double the bandwidth available for a two-way very small aperture terminal (VSAT). For example, in conventional two way VSAT systems the Hub and each of the many VSAT user terminals operate in the same frequency band (e.g., Ku band). Thus, the Hub takes a significant part of that frequency range (half of the sum of the uplink frequency range and the downlink frequency range). By reconfiguring the Hub to operate in a different frequency band such as Ka, the bandwidth available for the VSAT is doubled. This may be accomplished by including a frequency converter in the satellite to convert the frequency of the Ku band channels and forward the channels to a ground station or gateway on a different frequency band (e.g., Ka).

This is important since small terminals can use more efficiently the Ku band frequencies versus the Ka band frequencies. By operating the Hub in the less attractive/convenient band (e.g., Ka), the full Ku band is available for the small terminals. Thus, the Ku band available for the small terminals is doubled.

In still further aspects of the invention, a single satellite may provide generic or broad beam connectivity to provide for a more general use system, which may be switched to serve generic wide beam operations, narrow beam applications, or mixed mode applications as needed. This may have the result of substantially minimizing business risk by allowing the market to determine demand and then reconfiguring the satellite after launch to adapt to the service requirements. In these embodiments, a single satellite may be reconfigured for generic-usage connectivity for versatility and business risk mitigation. The reconfiguration discussed above may also be applicable to a dual satellite system.

A control circuit on the satellite and associated switch may allow the amplifiers on satellite to switch to unified (generic) coverage of all of the service area as opposed to spot beam array coverage. In this manner, the whole payload or portions of the payload may be switched from unified coverage to and from spot beam coverage. This may be done on a partial change basis to operate some channels with spot beam and some with uniform coverage, or on a system wide basis for each satellite. The above reconfigurations are performed via ground control.

In still further embodiments of the invention, the reconfiguration of the satellite may be accomplished in a variety of manners. For example, the cross-strap connectivity for doubling of the preferred bandwidth can be switched in or not.

Thus, both the generic broad beam coverage and the spot beam coverage may be operated using the cross strap connectivity between different bands such as the Ka and Ku bands. Thus both the generic and spot beam mode may be operated together, each in half of the frequency range. The above described channel arrangement and the cross strap connectivity configurations may be used together to maximize the efficiency of the satellite system.

These and other features of the invention will be apparent upon consideration of the following detailed description of preferred embodiments. Although the invention has been defined using the appended claims, the invention may include one or more aspects of the embodiments described herein including the elements and steps described in any combination or subcombination. For example, it is intended that each of the above aspects of the invention may be used individually and/or in combination with one or more other aspects of the invention defined above and/or in connection with the detailed description below. Accordingly, there are any number of alternative combinations for defining the invention, which incorporate one or more elements from the specification, including the description, claims, aspects of the invention, and/or drawings, in various combinations or subcombinations. Accordingly, it will be apparent to those skilled in satellite communication art in view of the present specification, that alternate combinations and subcombinations of one or more aspects of the present invention, either alone or in combination with one or more elements and/or steps defined herein, may constitute alternate aspects of the invention. It is intended that the written description of the invention contained herein cover all such modifications and alterations.

### BRIEF DESCRIPTION OF THE DRAWING

The foregoing summary of the invention, as well as the following detailed description of preferred embodiments, is better understood when read in conjunction with the accompanying drawings, which are included by the way of example, and not by way of limitation with regard to the claimed invention in the accompanying figure in which like reference numerals indicate similar elements.

FIG. 1 shows an exemplary block diagram of one set of the spot beam array in a single satellite system embodying aspects of the present invention.

FIG. 2. shows an exemplary block diagram of one set of the spot beam array using multiple satellites covering spot beam areas which may be separated and/or partially overlap.

FIGS. 3A-3C show an exemplary table depicting a method of channel arrangement for use in the above systems in accordance with embodiments of the invention.

FIG. 4 shows an exemplary map of spot beam coverage for the United Sates which includes 24 beams in six sets.

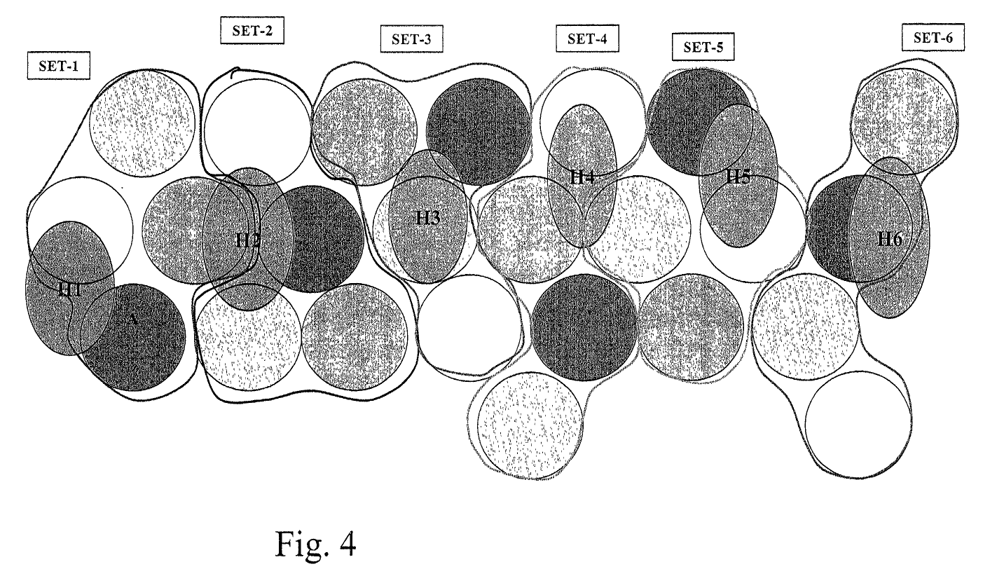

FIG. 5 shows a simplified block diagram of on-board control functions of the satellite communication payloads utilized in the above Figures.

FIG. 6 shows an exemplary map of alternative generic beam coverage for the United States.

FIG. 7 shows a exemplary basic channel arrangement in a single spot in a dual satellite system.

FIG. 8 shows an exemplary embodiment of an outbound single satellite single set example using aspects of the present invention.

FIG. 9 shows an exemplary embodiment of an outbound dual satellite single set example using aspects of the present invention.

FIG. 10 shows an exemplary embodiment of an inbound single satellite single set using aspects of the present invention.

FIG. 11 shows an exemplary embodiment of an inbound dual satellite single set example using aspects of the present invention.

FIG. 12 shows a table providing an example of the operation of embodiments of the present invention operating in a restoration mode.

FIG. 13 shows a table providing an example of the operation of embodiments of the present invention operating in an unequal allocation of capacity mode.

FIG. 14 shows a map providing an example of channel donation from one spot beam area to another.

FIG. 15 shows a map providing an example of improper channel donation.

FIG. 16 shows a technique for providing demand load balancing among spot beams.

FIG. 17 provides an example of a comparison of the capacity in two satellite—generic and multi-spot in accordance with the present invention.

### DETAILED DESCRIPTION OF THE INVENTION

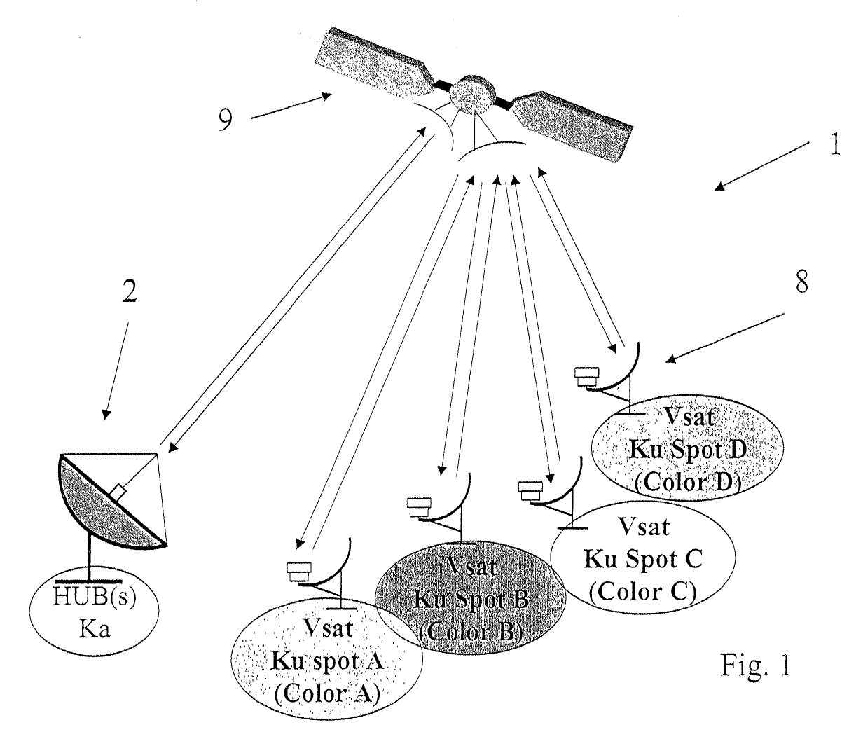

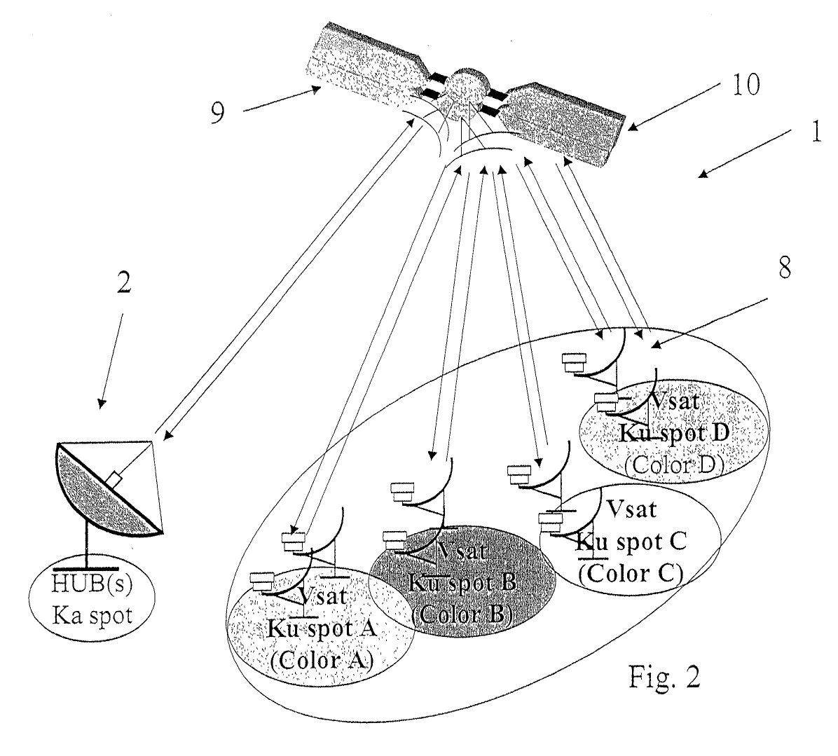

Referring to FIGS. 1 and 2, embodiments of one or more aspects of the present invention may include one or more satellites (e.g., Satellite I identified as element 9 and Satellite II identified as element 10) configured to include one or more sets of one or more spot beams (e.g., spot beam A-D) and one or more generic beams (G1-Gn). These satellites may direct one or more of a plurality of beams to one or more relatively confined geographic areas (spot beam areas) or to a broader (generic) area. For example, separate spot beams may be directed to Atlanta (spot Beam A), Washington DC(spot beam B), Miami (spot beam C), and Boston (spot beam D). All have different frequency channels which together are covering the whole frequency range in one polarization. We can repeat the same frequency range in second set of beams, e.g., St. Louis (spot Beam A), Chicago (spot beam B), Cincinnati C (spot beam C), and New Orleans (spot beam D) still working in the same polarization. In this example, each one of the four spots in a set takes one quarter of the frequency range. Any particular spot beam uses channels different in frequency and/or polarization from any adjacent spot beam area.

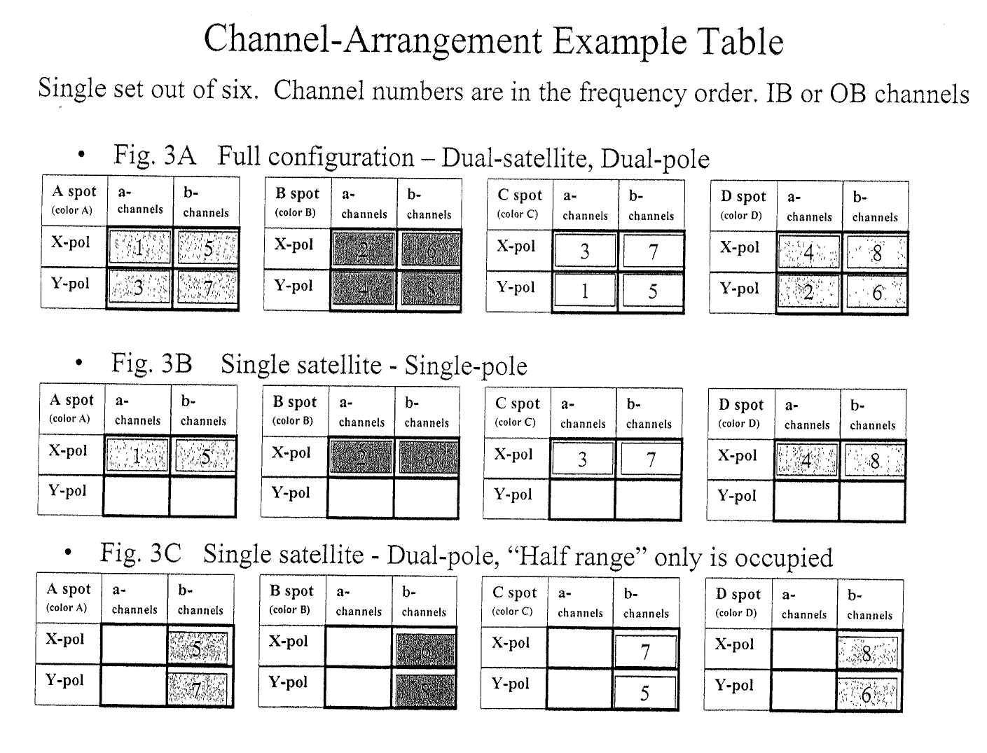

Further, it has been found that certain frequency channels and polarization arrangement provide superior performance in two-way communication systems such as those applicable to the present inventions. Specifically, referring to FIGS. 3A-3C, the A-D spot channels may be variously configured. For example, the available frequency spectrum (Ka or Ku) may be divided into a plurality of channels. In this example, the inbound frequencies have been divided into 8 channels and the outbound frequencies have been divided into 8 channels. The channel configuration shown in FIGS. 3A-3C provides an extremely efficient channel arrangement for providing hot backup multi-spot beam area coverage.

In alternate embodiments, one or more channels may be reserved for multicast channels directed to generic coverage. The multicast channels may carry any data currently carried by satellite transmission including electronic data such as Internet data, audio data, and video data.

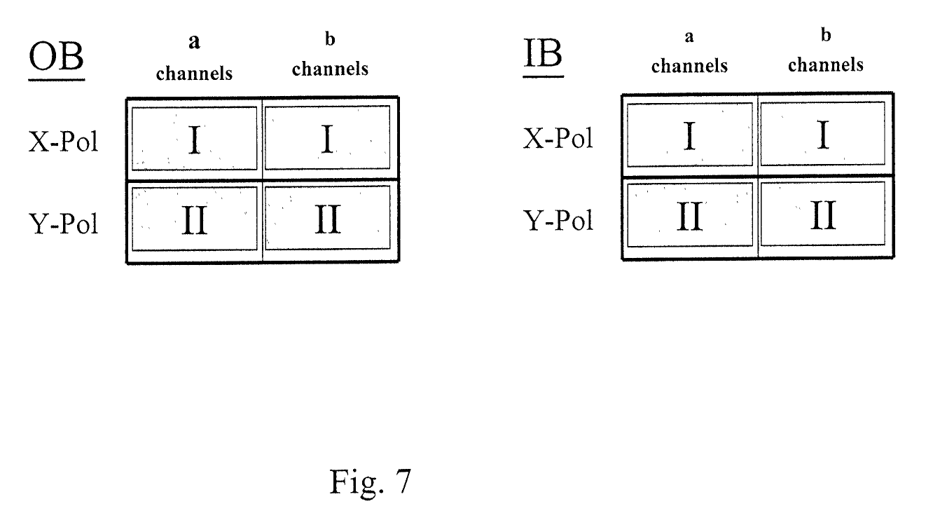

Referring to FIG. 7, satellite I may operate with one polarization for both a-channels and b-channels on both the outbound (OB) direction and the inbound (IB) direction. Similarly, satellite II may operate on the other polarization for both a-channels and b-channels on both the out bound (OB) direction and the in bound (IB) direction. Any number of permutations may be adapted for any one satellite such as only operating in a-channels or b-channels, or a-channels with x-polarization and b-channels with y-polarization, and/or with switching options between any of the foregoing configurations.

It is possible for a single satellite to cover all spot beam areas even where the other satellite has failed. As discussed above, each spot beam color area may be serviced by two collocated satellites (e.g., collocation within up to 0.5 degrees of separation). Where satellite 10 has failed, satellite 9 may continue to cover all spot areas A-D. With the frequency spacing discussed herein, it is possible to continue to supply channels to all spot areas in both polarizations with only one satellite.

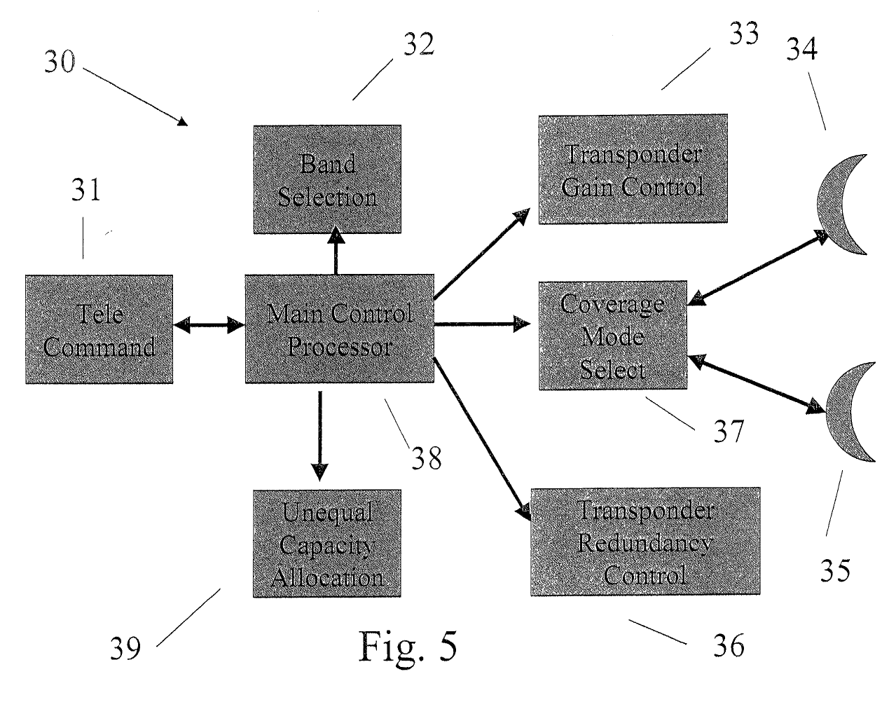

Referring to FIG. 5, a block diagram of an exemplary satellite payload 30 is shown. Telecommand control block 31 represents a conventional interface between the ground control and the satellite payload control 30. The telecommand control block 31 transfers commands to and from the main control processor 38. The main control processor 38 controls the satellite communication payload functions as described herein. For example, the main control processor 38 may activate a band selection control block 32, an unequal capacity allocation control block 39, a transponder gain control block 33, a transponder redundancy control 36 and a coverage mode selection control block 37 which enables switching (e.g., using switching of transponders) between a first antenna array 34 (spot beam) and second antenna array (generic beam) 35. Band selection control block 32 provides frequency band selection between different frequency bands such as Ku or Ka as discussed herein. The unequal capacity allocation control block 39 provides control functions for moving channels between spot beams. The transponder gain control block 33 conventionally provides adjustment of the gain control of the transponder between input and output.

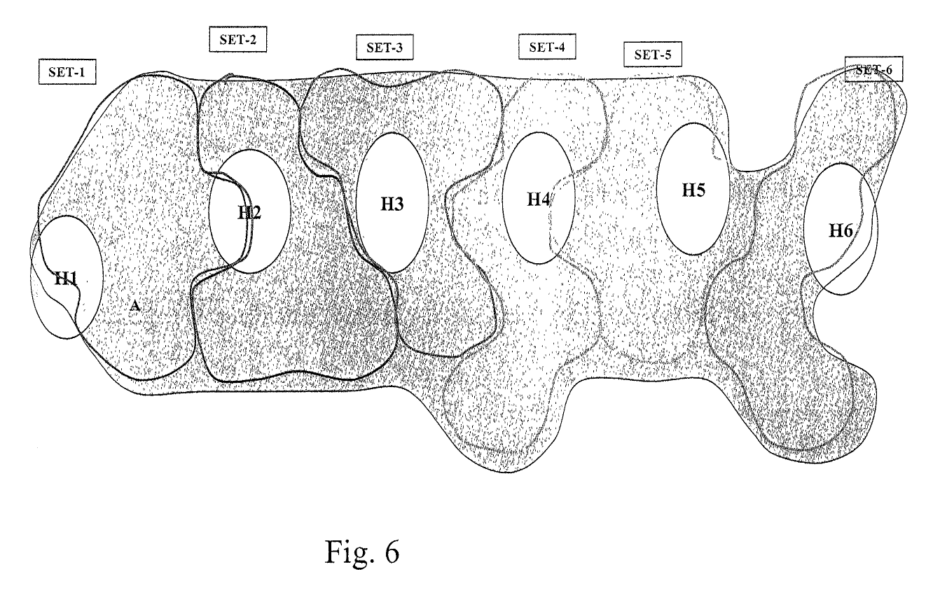

Referring to FIG. 6, the satellites 9, 10 may include a generic mode coverage in addition to and/or as an alternative to spot beam coverage. The illustrated example uses CONUS (contiguous United States) coverage. The generic coverage may be utilized for any suitable applications.

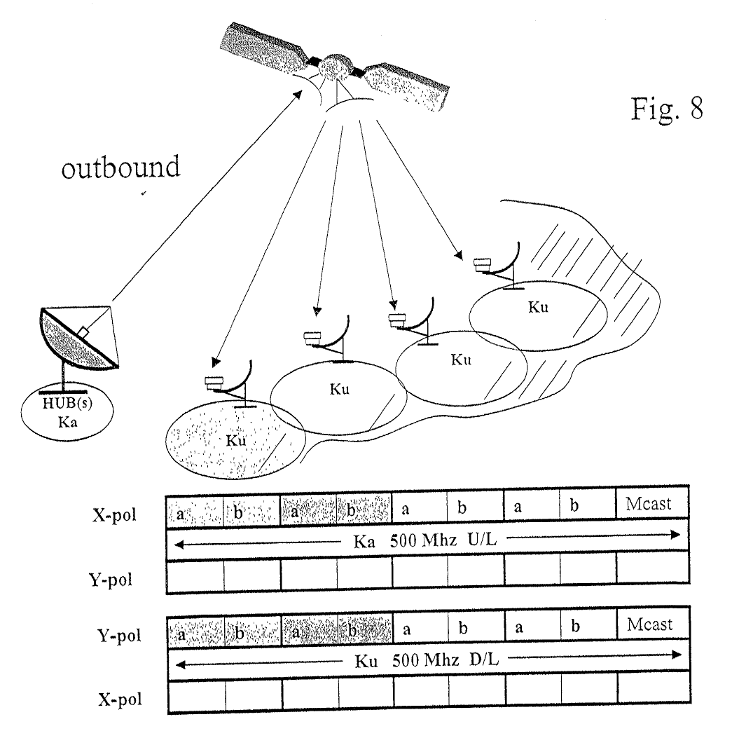

In the example described in FIG. 8, the outbound channels path going from the Hub (which may work in the Ka or Ku band) via the satellite to four spot beams (one set) to the small terminals (which may work in the Ku band). Additionally, a multicast channel may be associated with coverage of all of the service area. In this figure, a single satellite is shown providing the downlink directed y-polarization channels (color A-D a-channels, color A-D b-channels, and a multicast channel) spanning the full 500 MHz available in the Ku band (lower part of table). In this example, the uplink for the above mentioned downlink channels are similar channels which may be in this or another frequency band (e.g., the Ka frequency band). Thus, also in this figure, the single satellite is shown providing the uplink directed x-polarization channels (color A-D a-channels, color A-D b-channels, and a multicast channel) spanning the full 500 MHz available in the Ka band (upper part of table). Although it is preferred to switch the polarizations between the uplink and the downlink to provide better isolation, other configurations may be utilized with the same polarizations. Thus, FIG. 8 represents the single satellite eight channel half configuration including both the uplink and downlink directed channels for the outbound path only.

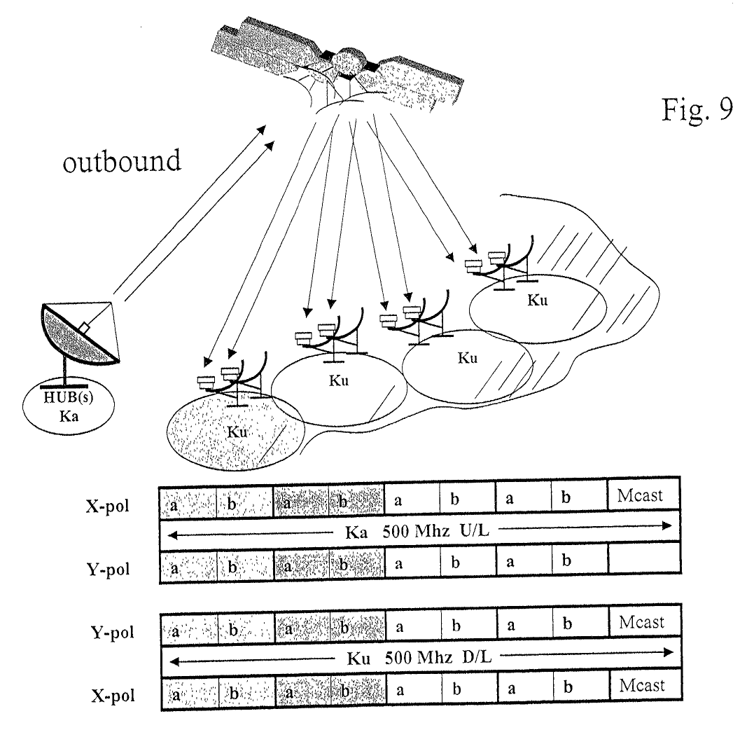

Referring to FIG. 9, a dual satellite configuration is shown in a manner similar to that shown in FIG. 8 above. In the configuration shown in FIG. 9, the outbound channels path going from the Hub (which may work in the Ka or Ku band) via the satellites to four spot beams (one set) to the small terminals (which may work in the Ku band). Additionally, a multicast channel may be associated with coverage of all of the service area. In this figure, a dual satellite is shown providing the downlink directed x-polarization and y-polarization channels (color A-D a-channels, color A-D b-channels, and a multicast channel) spanning the full 500 MHz available in the Ku band (lower part of table). In this example, the uplink for the above mentioned downlink channels are similar channels which may be in this or another frequency band (e.g., the Ka frequency band). Thus, also in this figure, the dual satellite is shown providing the uplink directed x-polarization and y-polarization channels (color A-D a-channels, color A-D b-channels, and a multicast channel) spanning the full 500 MHz available in the Ka band (upper part of table). Although it is preferred to switch the polarizations between the uplink and the downlink on any one given satellite to provide better isolation, other configurations may be utilized with the same polarizations. Thus, FIG. 9 represents the dual satellite eight channel full configuration including both the uplink and downlink directed channels for the outbound path only.

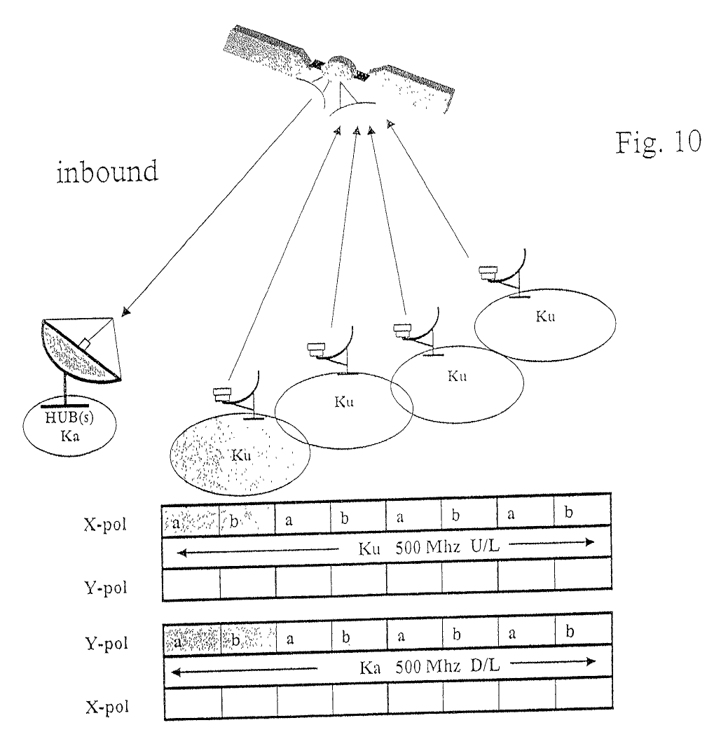

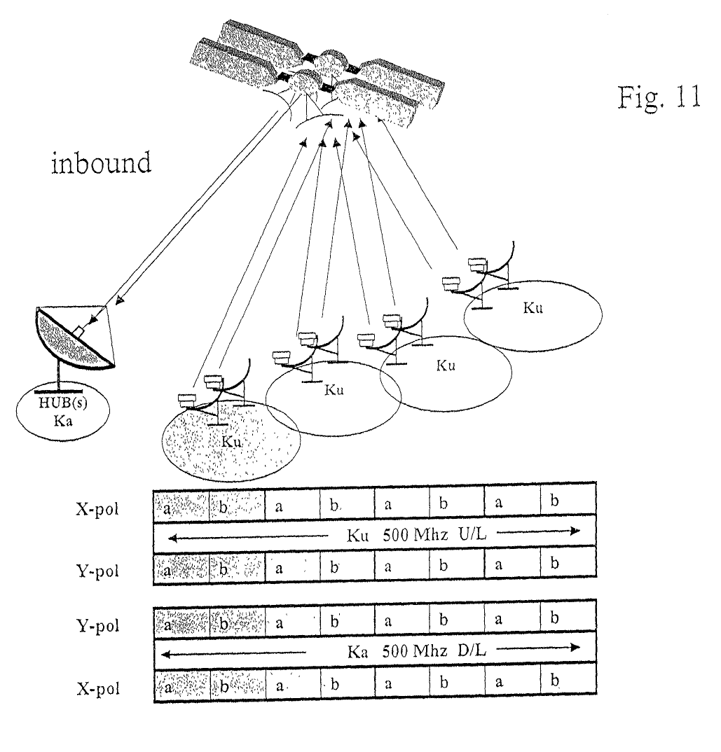

FIGS. 10 and 11 parallel FIGS. 8 and 9 except that FIGS. 10 and 11 illustrate the inbound path without the multicast channel. Referring to FIG. 10, in a single satellite is shown providing the uplink directed x-polarization channels (color A-D a-channels and color A-D b-channels) spanning the full 500 MHz available in the Ku band (upper part of table). In this example, the downlink for the above mentioned uplink channels are similar channels which may be in this or another frequency band (e.g., the Ka frequency band). Thus, also in this figure, the single satellite is shown providing the downlink directed y-polarization channels (color A-D a-channels and color A-D b-channels) spanning the full 500 MHz available in the Ka band (lower part of table). Although it is preferred to switch the polarizations between the uplink and the downlink to provide better isolation, other configurations may be utilized with the same polarizations. Thus, FIG. 10 represents the single satellite eight channel half configuration including both the uplink and downlink directed channels for the inbound path only.

Referring to FIG. 11, a dual satellite inbound configuration is shown in a manner similar to that shown in FIG. 10 above. In the configuration shown in FIG. 11, the inbound channels path going to the Hub (which may work in the Ka or Ku band) via the satellites from four spot beams (one set) associated with the small terminals (which may work in the Ku band). In this figure, a dual satellite is shown providing the uplink directed x-polarization and y-polarization channels (color A-D a-channels and color A-D b-channels) spanning the full 500 MHz available in the Ku band (upper part of table). In this example, the downlink for the above mentioned uplink channels are similar channels which may be in this or another frequency band (e.g., the Ka frequency band). Thus, also in this figure, the dual satellite is shown providing the downlink directed x-polarization and y-polarization channels (color A-D a-channels and color A-D b-channels) spanning the full 500 MHz available in the Ka band (lower part of table). Although it is preferred to switch the polarizations between the uplink and the downlink on any one given satellite to provide better isolation, other configurations may be utilized with the same polarizations. Thus, FIG. 11 represents the dual satellite eight channel full configuration including both the uplink and downlink directed channels for the inbound path only.

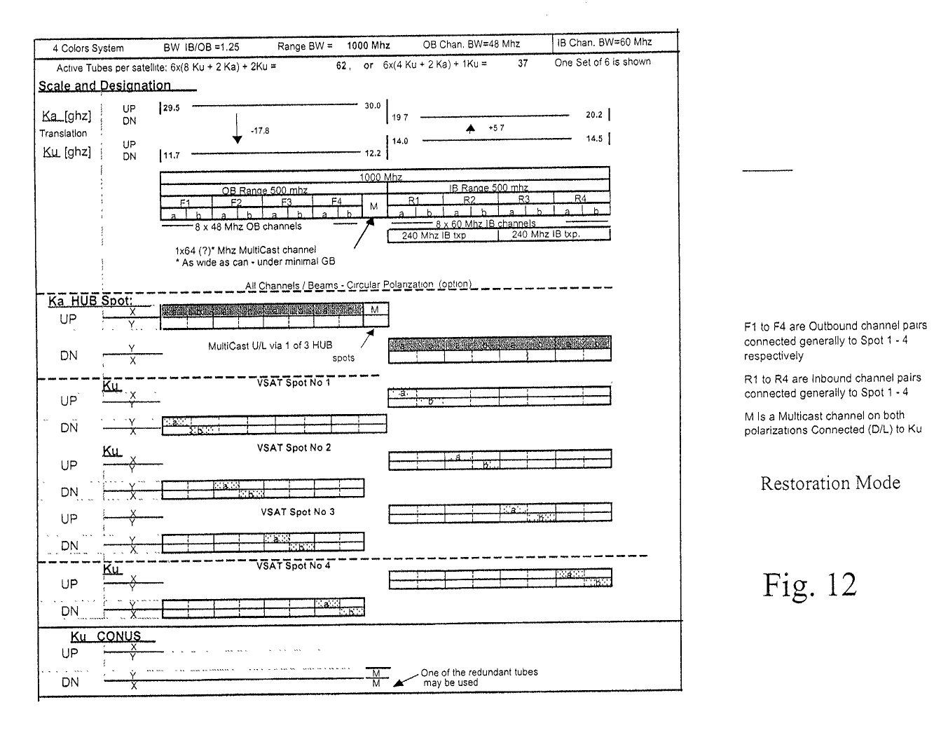

Referring to FIG. 12, a restoration mode is shown which occurs where one of the satellites is disabled and the remaining satellite must switch to single satellite channel configuration having two polarizations covering all four spot beam areas in each set. In this configuration, there are still two channels per spot beam color area in each orthogonal polarization in each direction as well as capacity for continuing to carry the multicast channel. The switching of the satellite as well as the various permutations in the configuration have been discussed above and need not be repeated with respect to FIG. 12.

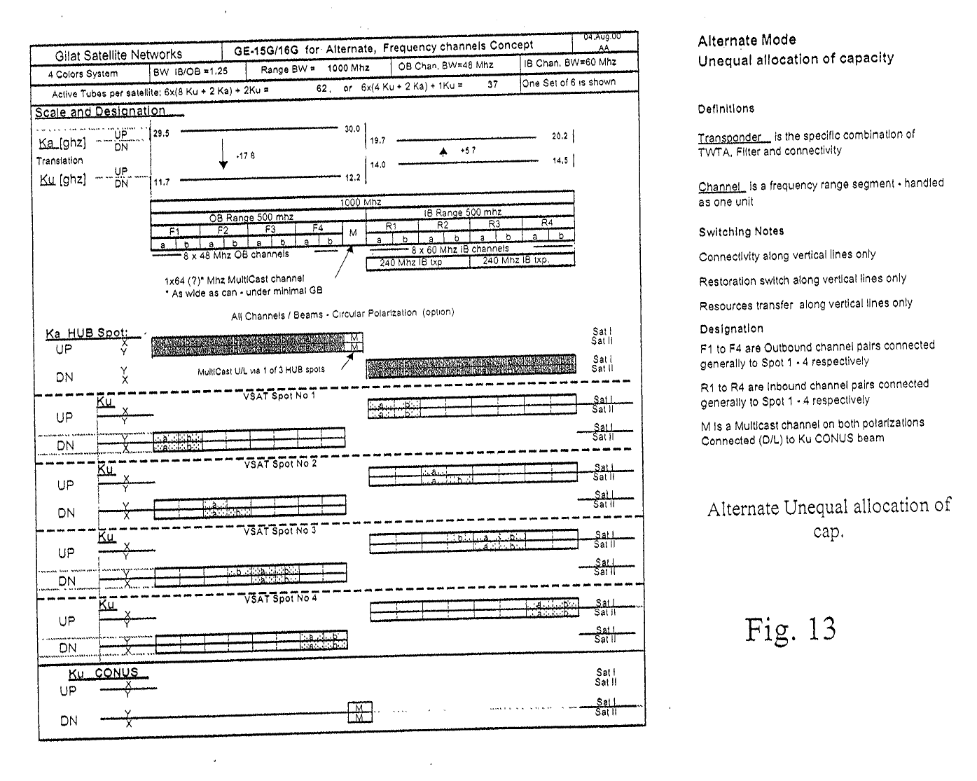

Referring to FIG. 13, a detailed chart representing unequal allocation of spot beam capacity among different spot beam areas within a set is shown. For example, where one spot (e.g., that covering Washington D.C.) requires extra capacity, it may be possible to borrow capacity from the spot beam area covering Atlanta. As shown in FIG. 13, a channel from spot beam area B (VSAT spot No. 2 in FIG. 13) may be allocated to spot beam area C (VSAT spot No. 3 in FIG. 13). In this manner, it is possible to transfer inbound channel and one outbound channel in the Ku band from one spot beam area to another within the same set. In some embodiments, it may be desirable to transfer up to four channels in both directions from two spot beams to a third in the same set.

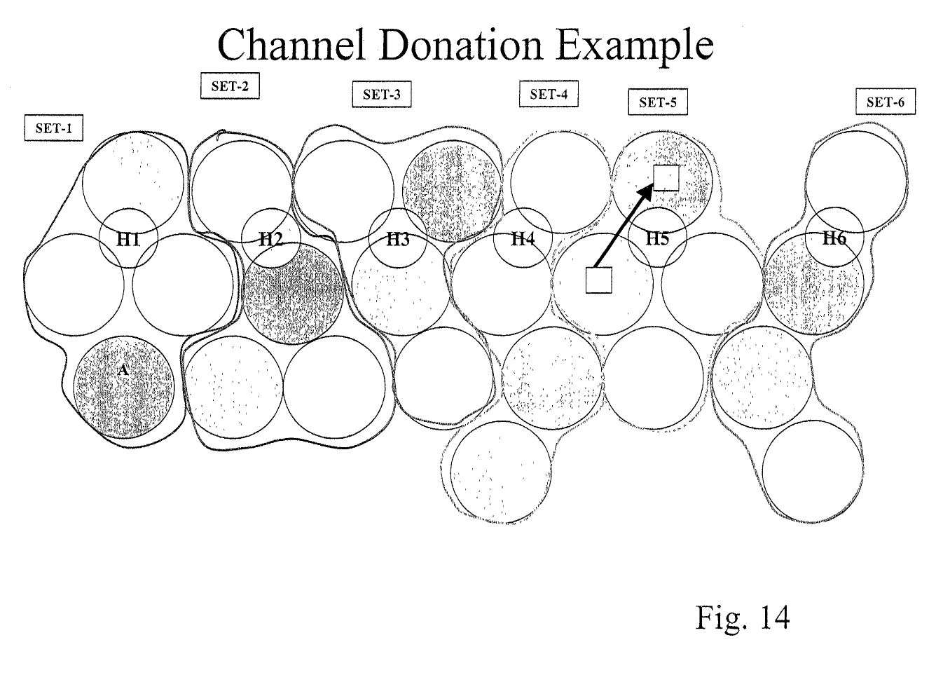

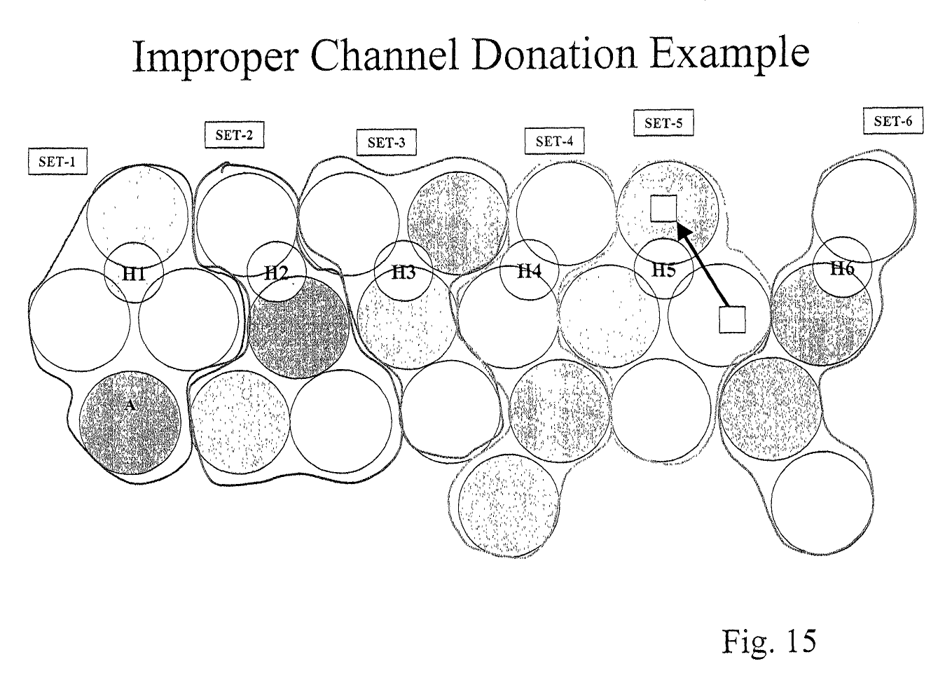

As shown in FIGS. 14 and 15, the color spot donation avoids any conflicts with adjacent sets. For example, while it is permissible to transfer channels from color spot A to color spot B in set 5 (see FIG. 14), it would not be permissible to transfer channels from color spot C to color spot B in set 5 (see FIG. 15). The reason for the limitation is that the transfer channel carries its original color and may not become adjacent to the same color due to the risk of interference. After channel donation, color spot B has 5 channels while color spot A has 3 channels in each direction.

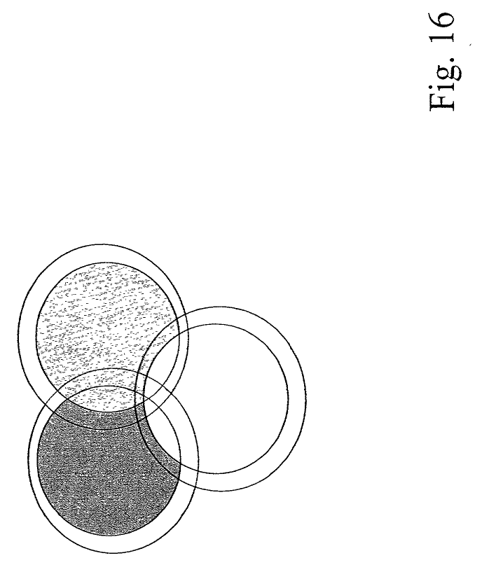

Referring to FIG. 16, the channel donation and demand load balancing may be applied to all color spot locations by utilizing existing beam spread overlap so that adjacent color spots overlap. Thus, a user may be moved from one set to another or from one color spot to another to balance the load among the various spots in order to avoid high user concentrations in some spots.

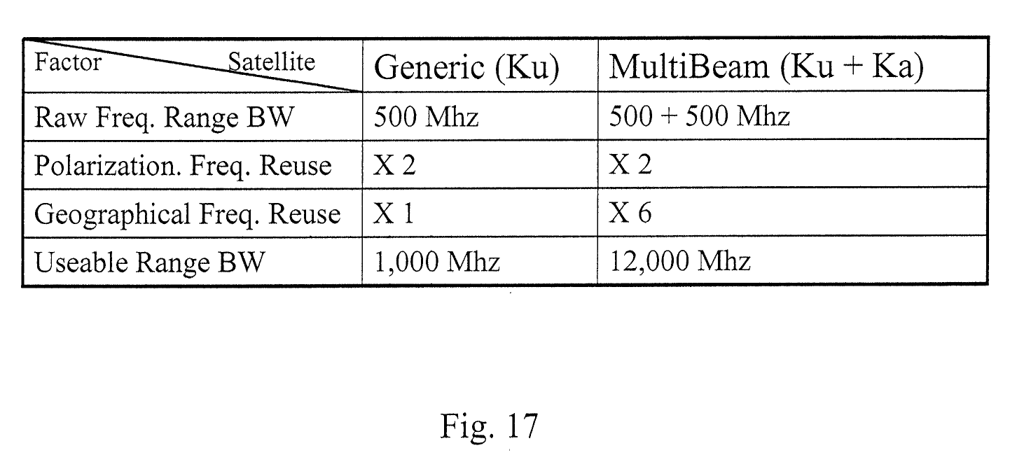

FIG. 17 illustrates the dramatic improvements in system capacity and cost savings achieved using embodiments of the present invention. As shown in FIG. 17, the overall capacity of the system has increased more than 12 fold from 1 GHz to 12 GHz with little or no increase in cost of the overall system. This is due to the combination of several mechanisms including embodiments of the present invention. Thus, the use cost per subscriber may be reduced substantially. Thus, two-way VSAT service may for the first time be cost competitive with land lines even in well developed areas.

We claim:

1. A method of providing hot back-up for a satellite communication satellite system comprising
collocating two satellites; and
utilizing a complementary channel arrangement for the two satellites which facilitates full dual pole coverage continuity when one of the satellites fails.

2. A system comprising:
a first satellite configured to include multi-spot beams having a first channel arrangement;
a second satellite, co-located with the first satellite, having a second channel arrangement complementary with the first channel arrangement.

3. A method of operating a two-way communication satellite communicating comprising:
receiving Ka band frequency channels from Hub and converting the Ka band frequency channels to Ku band frequency channels for downlink directed messages to a plurality of user terminals;
receiving Ku band frequency channels from a plurality of user terminals and converting the Ku band frequency channels into Ka band frequency channels and outputting the Ka band channels to the Hub.

4. An apparatus comprising:
a communication satellite comprising a first interface configured to communicate using Ka frequency band channels and a second interface configured to communicate using Ku frequency band channels;
a gateways configured to send and receive data to the communications satellite using the Ka frequency band channels; and
a plurality of user terminals configured to send and receive data to the communications satellite using Ku frequency band channels.

5. An method of operating a network operations center to control a satellite to receive Ka band frequency channels from a Hub and convert the Ka band frequency channels to Ku band frequency channels for downlink directed messages to a plurality of user terminals, and to receive Ku band frequency channels from a plurality of user terminals and to convert the Ku band frequency channels into Ka band frequency channels and output the Ka band channels to the Hub.

6. A multi-mode communication satellite comprising a two antenna system and a switch configured to switch a plurality of transponders between a spot beam mode and a generic beam mode.

7. The multi-mode communication satellite of claim 4 wherein the switch is configured to switch all of the transponders or a portion of the transponders.

8. A satellite comprising:
a first antenna system having multiple spot beams;
a satellite control configured to control the first antenna system to switch transponders from one spot beam to another responsive to control channels.
